(19) United States
(12) Patent Application Publication
(10) Pub. No.: US 2010/0053488 A1
(43) Pub. Date: Mar. 4, 2010

(54) LIQUID CRYSTAL DISPLAY

(75) Inventors: Jae-Hyun KIM, Suwon-si (KR); Gee-Bum Kim, Incheon (KR); Ji-Youn Choi, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/344,337

(22) Filed: Dec. 26, 2008

(30) Foreign Application Priority Data
Aug. 26, 2008 (KR) 10-2008-0083302

(51) Int. Cl. G02F 1/1343; G02F 1/1368; G02F 1/1335

(52) U.S. Cl. 349/48; 349/144; 349/96

(57) ABSTRACT

A liquid crystal display according to an exemplary embodiment of the present invention includes a first substrate and a second substrate. Gate lines are arranged on the first substrate, and an insulating layer is arranged on the gate lines. Data lines, first drain electrodes, and second drain electrodes are arranged on the insulating layer. First sub-pixel electrodes and second sub-pixel electrodes are connected to the first drain electrodes and second drain electrodes, respectively. Storage electrode lines are parallel to the gate lines, and traverse at least one of the first sub-pixel electrodes and second sub-pixel electrodes. A first polarizer is disposed on an outer surface of the first substrate, and a second polarizer is disposed on an outer surface of the second substrate. A first λ/4 plate is disposed between the first substrate and the first polarizer, and a second λ/4 plate is disposed between the second substrate and the second polarizer. A diffuser is disposed on an outer surface of the second polarizer. The storage electrode lines receive storage voltages that vary periodically.

### CROSS REFERENCE TO RELATED APPLICATION

This application claims priority from and the benefit of Korean Patent Application No. 10-2008-0083302, filed on Aug. 26, 2008, which is hereby incorporated by reference for all purposes as if fully set forth herein.

### BACKGROUND OF THE INVENTION

1. Field of the Invention

The present invention relates to a liquid crystal display.

2. Discussion of the Background

A liquid crystal display is one type of flat panel display that is currently widely used. A liquid crystal display has two display panels on which field generating electrodes such as pixel electrodes and common electrodes are formed, and a liquid crystal layer that is disposed between the panels. In a liquid crystal display, voltages are applied to the field generating electrodes to generate an electric field in the liquid crystal layer, and the alignment of liquid crystal molecules of the liquid crystal layer is determined by the electric field. Accordingly, the polarization of incident light may be controlled and an image may be displayed.

The liquid crystal display has switching elements connected to pixel electrodes, respectively, and a plurality of signal lines such as gate and data lines to apply voltages to the pixel electrodes by controlling the switching elements.

Among liquid crystal displays, a vertical alignment (VA) mode liquid crystal display, in which the direction of the liquid crystal molecules is perpendicular to the upper and lower display panels when no electric field is applied thereto, may have a high contrast ratio and a wide reference viewing angle. The reference viewing angle means a viewing angle with a contrast ratio of 1:10 or an intergray luminance inversion limitation angle.

With the VA mode liquid crystal display, lateral visibility may be poor compared with frontal visibility. In order to solve such a problem, it has been proposed that one pixel should be bisected into two sub-pixels, that receive different voltages.

Furthermore, because the liquid crystal display is a non-emissive type display device, a light emitted from a backlight separately provided at the backside of the liquid crystal display transmits light through a liquid crystal display, or an external light, such as sunlight, passes the liquid crystal layer and re-passes it by way of reflection, thereby displaying the desired image. The former case is called a transmission liquid crystal display, and the latter case a reflective liquid crystal display.

A transflective liquid crystal display, which uses a backlight or an external light depending upon the given circumstances, has recently been developed, and is mainly used for small or medium-sized display devices.

### SUMMARY OF THE INVENTION

The present invention provides a liquid crystal display that may have a wide viewing angle and enhanced visibility.

Additional features of the invention will be set forth in the description which follows, and in part will be apparent from the description, or may be learned by practice of the invention.

The present invention discloses a liquid crystal display having a first substrate and a second substrate. Gate lines are arranged on the first substrate, and an insulating layer is arranged on the gate lines. Data lines, first drain electrodes, and second drain electrodes are arranged on the insulating layer. First sub-pixel electrodes and second sub-pixel electrodes are connected to the first drain electrodes and second drain electrodes, respectively. Storage electrode lines are parallel to the gate lines and traverse at least one of the first sub-pixel electrodes and the second sub-pixel electrodes. A first polarizer is disposed on an outer surface of the first substrate, and a second polarizer on an outer surface of the second substrate. A first λ/4 plate is disposed between the first substrate and the first polarizer, and a second λ/4 plate is disposed between the second substrate and the second polarizer. A diffuser is disposed on an outer surface of the second polarizer. The storage electrode lines receive storage voltages that vary periodically.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of a liquid crystal display according to an exemplary embodiment of the present invention.

FIG. 2 is a cross-sectional view of the liquid crystal display shown in FIG. 1 taken along line II-II thereof.

FIG. 3 is an equivalent circuit diagram of two sub-pixels in a liquid crystal display according to an exemplary embodiment of the present invention.

FIG. 4 is a waveform diagram of signals applied to pixels of one row and voltages of sub-pixel electrodes in a liquid crystal display according to an exemplary embodiment of the present invention.

FIG. 5 is a schematic cross-sectional view of a liquid crystal display according to an exemplary embodiment of the present invention.

FIG. 6 shows directions of axes of films of the liquid crystal display shown in FIG. 5.

FIG. 7 is a schematic cross-sectional view of a liquid crystal display according to another exemplary embodiment of the present invention.

FIG. 8 shows directions of axes of films of the liquid crystal display shown in FIG. 7.

FIG. 9 is a layout view of a liquid crystal display according to another exemplary embodiment of the present invention.

FIG. 10 is a cross-sectional view of the liquid crystal display shown in FIG. 9 taken along line X-X thereof.

FIG. 11 is a schematic cross-sectional view of a liquid crystal display according to an exemplary embodiment of the present invention.

FIG. 12 shows the axial directions of films of the liquid crystal display shown in FIG. 11.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, directly connected to, or directly coupled to the other element or layer, or intervening elements or layers may be present. In contrast, when an element is referred to as being “directly on”, “directly connected to”, or “directly coupled to” another element or layer, there are no intervening elements or layers present.

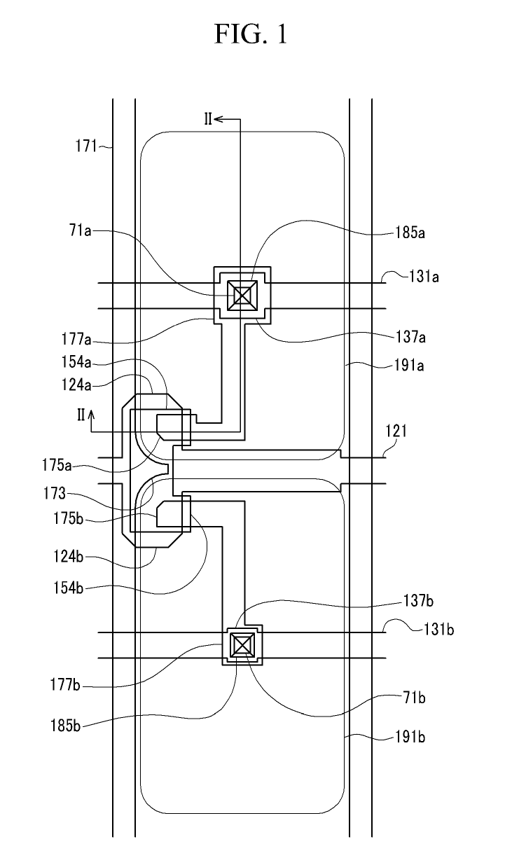

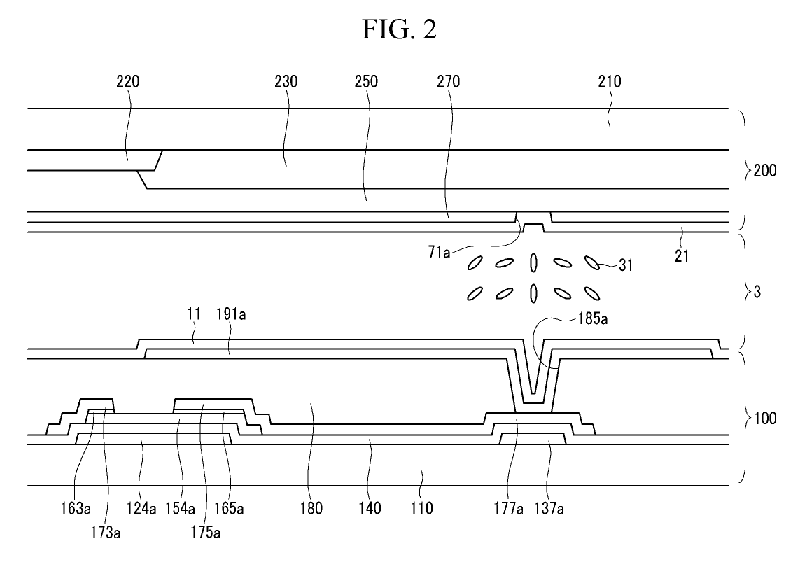

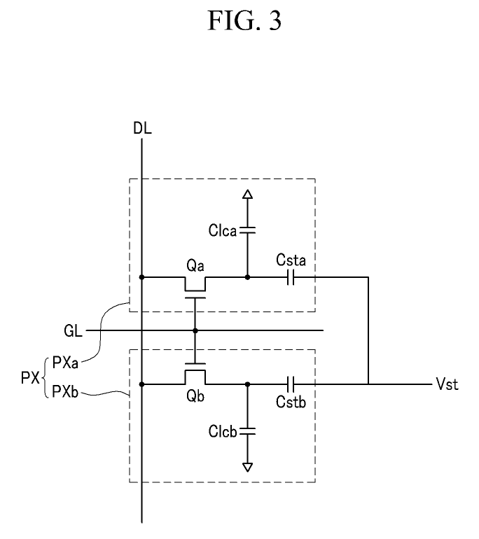

A liquid crystal display according to an exemplary embodiment of the present invention will be described in detail with reference to FIG. 1, FIG. 2, and FIG. 3.

FIG. 1 is a layout view of a liquid crystal display according to an exemplary embodiment of the present invention, FIG. 2 is a cross-sectional view of the liquid crystal display shown in FIG. 1 taken along line II-II thereof, and FIG. 3 is an equivalent circuit diagram of two sub-pixels in a liquid crystal display according to an exemplary embodiment of the present invention.

Referring to FIG. 1 and FIG. 2, a liquid crystal display according to an exemplary embodiment of the present invention includes a thin film transistor array panel 100 and a common electrode panel 200 facing each other, and a liquid crystal layer 3 disposed between the two panels 100 and 200.

The thin film transistor array panel 100 is first described in detail.

Gate conductors, including a plurality of gate lines 121 and a plurality of pairs of first and second storage electrode lines 131a and 131b, are formed on an insulation substrate 110, which may be made of transparent glass or plastic.

The gate lines 121 transmit gate signals and extend substantially in the horizontal direction. Each gate line 121 has a plurality of pairs of first and second gate electrodes 124a and 124b protruding up and down, respectively.

The first and second storage electrode lines 131a and 131b transmit storage voltages Vst that vary periodically, and extend substantially parallel to the gate lines 121. The first and second storage electrode lines 131a and 131b are disposed over and below the gate line 121, respectively, and spaced apart from the gate lines 121 at the substantially same distance. The first and second storage electrode lines 131a and 131b have a plurality of first and second storage electrodes 137a and 137b where the widths of the first and second storage electrode lines 131a and 131b are respectively increased. The first and second storage electrodes 137a and 137b may differ in size from each other.

The shapes and disposition of the gate lines 121 and the storage electrode lines 131a and 131b may be altered in various manners.

A gate insulating layer 140 is formed on the gate conductors 121, 131 a, and 131b, and may be made of silicon nitride (SiNx) or silicon oxide (SiOx).

A plurality of first and second semiconductor islands 154a and 154b are formed on the gate insulating layer 140 and may be made of hydrogenated amorphous silicon (a-Si) or polysilicon. The semiconductor islands 154a and 154b are disposed on the first and second gate electrodes 124a and 124b.

A pair of ohmic contact islands 163a and 165a are formed on the respective first semiconductor island 154a, and a pair of ohmic contact islands (not shown) are also formed on the respective second semiconductor island 154b. The ohmic contacts 163a and 165a may be formed of n+ hydrogenated amorphous silicon where n-type impurities, such as phosphorous, are doped at high concentration, or silicide.

Data conductors, including a plurality of data lines 171 and a plurality of pairs of first and second drain electrodes 175a and 175b, are formed on the ohmic contacts 163a and 165a and the gate insulating layer 140.

The data lines 171 transmit data signals and extend substantially in the vertical direction such that they cross the gate lines 121 and the storage electrode lines 131a and 131b. Each data line 171 has a plurality of source electrodes 173 protruding between the first and second gate electrodes 124a and 124b.

The first drain electrode 175a is disposed on the ohmic contact 165a, and has an end portion facing the source electrode 173, and another wide end portion 177a disposed over the storage electrode 137a. The second drain electrode 175b and the first drain electrode 175a are symmetrical in shape with respect to the gate line 121. The wide end portions 177a and 177b of the first and second drain electrodes 175a and 175b overlap the first and second storage electrodes 137a and 137b.

Areas of the wide end portions 177a and 177b of the first and second drain electrodes 175a and 175b may differ from each other. It is shown in FIG. 1 that the wide end portion 177a of the first drain electrode 175a as well as the first storage electrode 137a has an area greater than the area of the wide end portion 177b of the second drain electrode 175b as well as the second storage electrode 137b, or vice versa.

The first gate electrode 124a, the source electrode 173, the first drain electrode 175a, and the first semiconductor island 154a form a first thin film transistor (TFT) Qa, as shown in FIG. 3. The second gate electrode 124b, the source electrode 173, and the second drain electrode 175b, and the second semiconductor island 154b form a second thin film transistor (TFT) Qb, as also shown in FIG. 3. The channels of the first and second thin film transistors Qa and Qb are formed at the first and second semiconductor islands 154a and 154b, between the source electrode 173 and the first and second drain electrodes 175a and 175b, respectively.

The ohmic contacts 163a and 165a are present only between the underlying semiconductor islands 154a and 154b and the overlying data lines 171 and drain electrodes 175a and 175b so as to lower the contact resistance therebetween. The semiconductors islands 154a and 154b have exposed portions not covered by the data lines 171 and the drain electrodes 175a and 175b, including the portions between the source electrode 173 and the drain electrodes 175a and 175b.

A passivation layer 180 is formed on the data lines 171, the drain electrodes 175a and 175b, and the exposed portions of the semiconductor islands 154a and 154b. The passivation layer 180 may be formed of an inorganic insulator or an organic insulator. The passivation layer 180 may have a flat surface. The inorganic insulator may be selected from silicon nitride or silicon oxide. The organic insulator may have photosensitivity, and the dielectric constant thereof may be about 4.0 or less. Alternatively, the passivation layer 180 may have a double-layered structure including a lower inorganic layer and an upper organic layer such that may not harm the exposed portions of the semiconductor islands 154a and 154b while exerting the excellent insulating characteristics of an organic layer.

Contact holes 185a and 185b exposing the wide end portions 177a and 177b of the drain electrodes 175a and 175b are formed in the passivation layer 180. The contact holes 185a and 185b are disposed at the center of the drain electrodes 175a and 175b.

First and second sub-pixel electrodes 191a and 191b are formed on the passivation layer 180. The first and second sub-pixel electrodes 191a and 191b are bisected with respect to the gate line 121. The first and second sub-pixel electrodes 191a and 191b may be made of a transparent conductive material such as ITO and IZO.

The sub-pixel electrodes 191a and 191b may each be substantially rectangular-shaped with round edges, and occupy nearly all the space between adjacent data lines 171.

The first and second sub-pixel electrodes 191a and 191b are connected with the first and second drain electrodes 175a and 175b of the first and second thin film transistors Qa and Qb through the contact holes 185a and 185b, respectively, and receive the same data voltage from the first and second drain electrodes 175a and 175b.

The common electrode panel 200 is now described in detail.

A plurality of light blocking members 220 are formed on an insulation substrate 210 that may be made of transparent glass or plastic. The light blocking member 220, also called a black matrix, blocks leakage of light at the gaps between the pixel electrodes 191.

A plurality of color filters 230 are formed on the substrate 110 and the light blocking members 220. The color filters 230 are mostly existent within the openings defined by the light blocking members 220. The color filter 230 may longitudinally extend along the openings between two neighboring light blocking members 220 in the vertical direction. The color filter 230 may represent one of three primary colors, such as red, green, or blue.

An overcoat 250 is formed on the color filters 230 and the light blocking members 220. The overcoat 250 may be formed of an insulator, which may be an organic insulator. The overcoat 250 prevents the color filters 230 from being exposed, and presents a flattened surface. The overcoat 250 may be omitted.

A common electrode 270 is formed on the overcoat 250. The common electrode 270 may be formed of a transparent conductor such as ITO and IZO, and receives a common voltage.

A plurality of pairs of first and second openings 71a and 71b are formed in the common electrode 270. The first and second openings 71a and 71b are disposed corresponding to the center regions of the first and second sub-pixel electrodes 191a and 191b.

Alignment layers 11 and 21 are coated on inner surfaces of the two display panels 100 and 200. The alignment layers 11 and 21 may be vertical alignment layers.

The liquid crystal layer 3 has negative dielectric anisotropy, and liquid crystal molecules 31 of the liquid crystal layer 3 are aligned to be substantially perpendicular to the surface of the two display panels 100 and 200 in the absence of an electric field.

When a common voltage is applied to the common electrode 270 while a data voltage is applied to the pixel electrode 191, an electric field is generated substantially perpendicular to the surface of the display panels 100 and 200. In the present exemplary embodiment, the electric field is distorted near the regions where the openings 71a and 71b of the common electrode 270 are located. The liquid crystal molecules 31 tend to be oriented in response to the electric field such that their axes are substantially perpendicular to the direction of the electric field. In the present exemplary embodiment, the inclination directions of the liquid crystal molecules 31 are dispersed in a radial manner due to the electric field distorted by the openings 71a and 71b in the common electrode 270. In this way, the liquid crystal molecules 31 may be inclined in various directions. Accordingly, the reference viewing angle of the liquid crystal display may be widened, and the response speed of the liquid crystal molecules may be improved.

Furthermore, the degree of change in polarization of light incident into the liquid crystal layer 3 varies depending upon the inclination of the liquid crystal molecules 31.

The first and second sub-pixel electrodes 191a and 191b and the common electrode 270 of the common electrode panel 200 with the liquid crystal layer 3 disposed therebetween form first and second liquid crystal capacitors Clca and Clcb shown in FIG. 3, to maintain the applied voltages even after the thin film transistors Qa and Qb are turned off.

The wide end portions 177a and 177b of the first and second drain electrodes 175a and 175b connected to the first and second sub-pixel electrodes 191a and 191b overlap the first and second storage electrodes 137a and 137b with the gate insulating layer 140 therebetween to form first and second storage capacitors Csta and Cstb shown in FIG. 3. The first and second storage capacitors Csta and Cstb reinforce the voltage storage capacity of the first and second liquid crystal capacitors Clca and Clcb.

The first and second storage capacitors Csta and Cstb differ in capacitance from each other, and the capacitances thereof may be determined by controlling the overlapping areas of the first and second drain electrodes 175a and 175b and the first and second storage electrodes 137a and 137b. In the present exemplary embodiment, as shown in FIG. 1, the overlapping area of the first drain electrode 175a and the first storage electrode 137a is larger than that of the second drain electrode 175b and the second storage electrode 137b, and accordingly, the storage capacitance of the first storage capacitor Csta is greater than that of the second storage capacitor Cstb.

The capacitances of the first and second storage capacitors Csta and Cstb may be changed by varying the distances between two terminals of the capacitors Csta and Cstb or the dielectrics, besides controlling the overlapping areas of the first and second drain electrodes 175a and 175b and the first and second storage electrodes 137a and 173b as the two terminals.

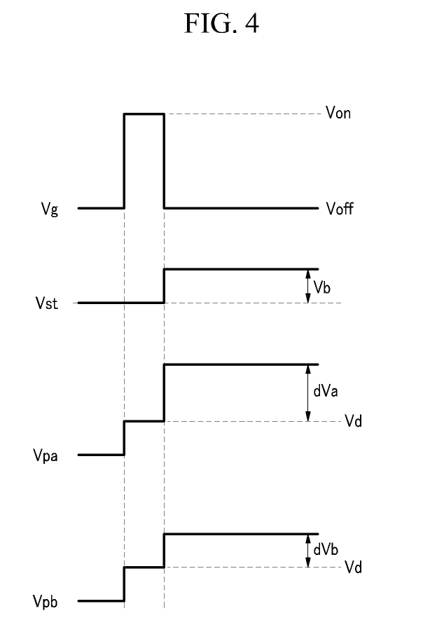

An operation of the liquid crystal display shown in FIG. 1, FIG. 2, and FIG. 3 will now be described in detail with reference to FIG. 3 and FIG. 4, together with the previously-described drawings of FIG. 1 and FIG. 2.

FIG. 4 is a waveform diagram of signals applied to pixels of one row and voltages of sub-pixel electrodes in a liquid crystal display according to an exemplary embodiment of the present invention.

The first and second thin film transistors Qa and Qb connected to the data lines DL and the gate lines GL, the first and second liquid crystal capacitors Clca and Clcb, and the first and second storage capacitors Csta and Cstb, form first and second sub-pixels PXa and PXb, respectively. The first and second sub-pixels PXa and PXb form one pixel PX.

When the gate signal Vg applied to the gate line 121 becomes a gate-on voltage Von, the first and second thin film transistors Qa and Qb turn on, and accordingly, the voltages Vpa and Vpb of the first and second sub-pixel electrodes 191a and 191b functioning as common terminals of the first and second liquid crystal capacitors Clca and Clcb and the first and second storage capacitors Csta and Cstb become a data voltage Vd.

When the gate signal Vg becomes a gate-off voltage Voff, the first and second thin film transistors Qa and Qb turn off, and accordingly, the first and second sub-pixel electrodes 191a and 191b are in a floating state.

When the storage voltage Vst applied to the storage electrode lines 131a and 131b is changed by an amount of the boost voltage Vb, the voltages Vpa and Vpb of the first and second sub-pixel electrodes 191a and 191b vary accordingly. The voltage variations dVa and dVb of the voltages Vpa and Vpb are different depending upon the capacitance of the first and second storage capacitors Csta and Cstb, as shown by the following Equation 1.

$$dVa = \frac{Csta}{Csta + Clca + Cgda} , dVb = \frac{Cstb}{Cstb + Clcb + Cgdb} \qquad Equation 1$$

In Equation 1, Cgda and Cgdb are capacitances of parasitic capacitors that are formed as the first and second drain electrodes 175a and 175b overlap the first and second gate electrodes 124a and 124b, respectively.

In case where the capacitance of the first storage capacitor Csta is greater than that of the second storage capacitor Cstb, the voltage variation dVa of the first sub-pixel electrode 191a is greater than the voltage variation dVb of the second sub-pixel electrode 191b. In this way, as the capacitances of the first storage capacitor Csta and the second storage capacitor Cstb are different from each other, the voltages Vpa and Vpb of the first and second sub-pixel electrodes 191a and 191b become different from each other, and accordingly, the luminances of the first sub-pixel PXa and the second sub-pixel PXb become different from each other as well. In this way, when the two sub-pixels PXa and PXb differ in luminance from each other, the visibility of the liquid crystal display may be enhanced.

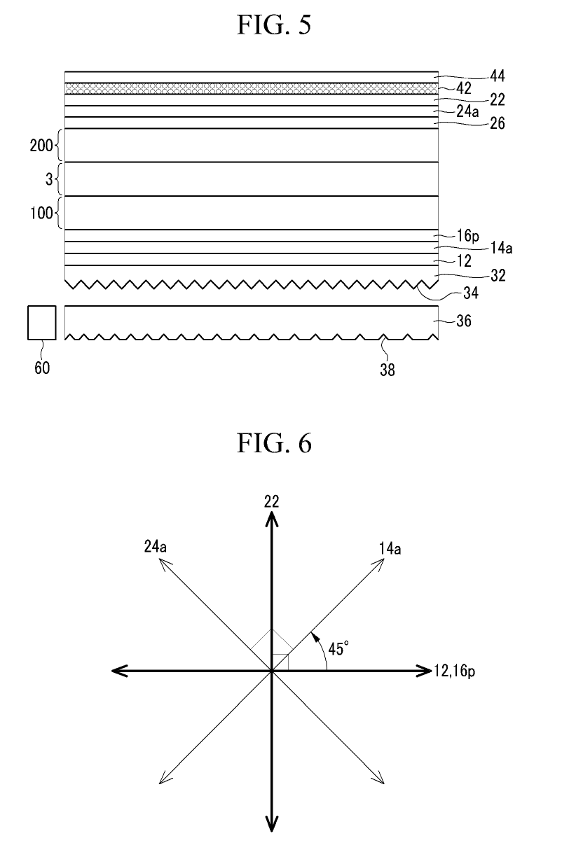

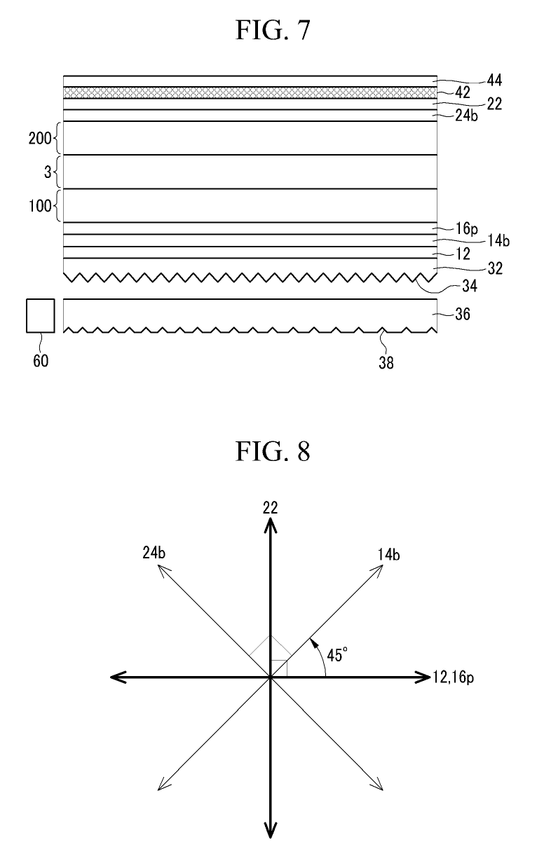

In the liquid crystal display shown in FIG. 1 and FIG. 2, a plurality of optical films or layers disposed on the outer surfaces of the display panels 100 and 200 will be now described in detail with reference to FIG. 5, FIG. 6, FIG. 7, and FIG. 8.

FIG. 5 is a schematic cross-sectional view of a liquid crystal display according to an exemplary embodiment of the present invention, and FIG. 6 shows the axial directions of films of the liquid crystal display shown in FIG. 5. FIG. 7 is a schematic cross-sectional view of a liquid crystal display according to another exemplary embodiment of the present invention, and FIG. 8 shows the axial directions of films of the liquid crystal display shown in FIG. 7.

Referring to FIG. 5, lower and upper compensation films 16p and 26, lower and upper λ/4 plates 14a and 24a, and lower and upper polarizers 12 and 22 are sequentially attached to the outer surfaces of a thin film transistor array panel 100 and a common electrode panel 200 of a liquid crystal display according to an exemplary embodiment of the present invention.

The lower and upper polarizers 12 and 22 each have a transmission axis, and the axes of the lower and upper polarizers 12 and 22 are disposed such that they are perpendicular to each other. The polarizers 12 and 22 have a structure in which triacetate cellulose (TAC) films are attached to both surfaces of a polyvinyl alcohol (PVA) base.

The lower compensation film 16p may be biaxial and may include an NEZ film. The lower compensation film 16p compensates for the angular variation between the transmission axes of the lower and upper polarizers 12 and 22 according to the viewing angles. As shown in FIG. 6, the slow axis of the lower compensation film 16p may coincide with the transmission axis of the lower polarizer 12. The refractive index ratio Nz of the lower compensation film 16p satisfies the following Equation 2, and the value thereof may be 0 to 0.2.

$$Nz = \frac{nx - nz}{nx - ny} \qquad Equation 2$$

In Equation 2, nx, ny, and nz are refractive indices in the x- and y-axes directions, which are surface directions of the compensation film 16p and the z-axis direction, which is perpendicular to the surface directions, respectively.

The upper compensation film 26 compensates for the phase differences in the cell-gap direction in the liquid crystal layer 3 according to the viewing angle. The upper compensation film 26 may include a C-plate or a biaxial film having a phase retardation value Rth in a predetermined thickness direction. For example, the upper compensation film 26 may have a phase retardation value Rth of 220 nm in the thickness direction with respect to light of a wavelength of 550 nm.

The lower and upper compensation films 16p and 26 may be exchanged with each other, or another C-plate or biaxial film may be further attached to the outer surface of the thin film transistor array panel 100.

The lower and upper λ/4 plates 14a and 24a grant a phase difference of 1/4 wavelength, and either convert linear polarization into circular polarization (or oval polarization) or convert circular polarization into linear polarization. Hereinafter, the term “circular polarization” will include oval polarization.

The slow axes of the lower and the upper λ/4 plates 14a and 24a may be perpendicular to each other. Furthermore, the slow axes of the lower and upper λ/4 plates 14a and 24a may form an angle of 45 degrees with the transmission axes of the lower and upper polarizers 12 and 22, respectively, or possibly other degrees. The lower and upper λ/4 plates 14a and 24a may be uniaxial.

Referring to FIG. 5 again, an inversion-prism sheet 32 and a light guide plate 36 are disposed under the lower polarizer 12, and a lamp 60 is provided beside the light guide plate 36 as a light source. A diffuser 42 and an anti-reflection layer 44 are sequentially disposed on the upper polarizer 22.

The diffuser 42 uniformly diffuses light incident from the bottom toward the top. The diffuser 42 may be formed by coating a film with a diffusion adhesive including light diffusion particulates to improve light transmittance and hard-coating the coated film, or by hardening a resin including light diffusion particulates. The haze degree of the diffuser 42 may be 80-90%, and the size or refractive index of the light diffusion particulates may be varied so as to diffuse light incident from the bottom only toward the top. Instead of providing a diffuser 42, the upper surface of the polarizer 22 may be surface-treated to function as a diffuser.

The anti-reflection layer 44 includes at least two layers having different refractive indices from each other. Light reflected from the surfaces of the respective layers of the anti-reflection layer 44 experience destructive interference with each other so as to weaken the light incident from the outside and reflected. The anti-reflection layer 44 may be formed by depositing titanium oxide (TiO2) and silicon oxide (SiO2) through spin-coating or sputtering.

Chevron-shaped grooves 38 for diffused reflection are formed on the bottom surface of the light guide plate 36 to diffuse light from the lamp 60 toward the display panels 100 and 200. The distances between neighboring chevron-shaped grooves 38 may increase with increasing distance from the lamp 60. The grooves formed on the bottom surface of the light guide plate 36 may have other shapes or be patterned in an irregular or regular manner.

The inversion-prism sheet 32 includes prisms 34 directed toward the underlying light guide plate 36, and collects light from the lamp 60 together with the light guide plate 36 so as to make the light proceed uniformly in a direction perpendicular to the surface of the display panels 100 and 200.

In this way, light from the lamp 60 proceeds in a direction perpendicular to the surface of the display panels 100 and 200 by way of the light guide plate 36 and the inversion-prism sheet 32. Also, light having passed the display panels 100 and 200 and the liquid crystal layer 3 may be uniformly diffused toward the front by way of the diffuser 42. As a result, the viewing angle of the liquid crystal display may be enhanced.

The lamp 60 may be a light emitting diode (LED).

With this structure, the viewing angle of the liquid crystal display may be widened, and lateral visibility may be enhanced.

A plurality of optical films or layers disposed on the outer surfaces of the display panels 100 and 200 of a liquid crystal display according to another exemplary embodiment of the present invention will now be described in detail with reference to FIG. 7 and FIG. 8.

Referring to FIG. 7, in a liquid crystal display according to the present exemplary embodiment, a lower compensation film 16p, a lower λ/4 plate 14b, and a lower polarizer 12 are sequentially attached to the outer surface of the thin film transistor array panel 100, and an upper λ/4 plate 24b and an upper polarizer 22 are sequentially attached to the outer surface of the common electrode panel 200.

Differently from the liquid crystal display shown in FIG. 5 and FIG. 6, in the present exemplary embodiment, an upper compensation film 26 is not existent. Instead, the lower and upper λ/4 plates 14b and 24b are biaxial and have phase a retardation value Rth in the thickness direction, which compensates for the phase difference in the cell-gap direction of the liquid crystal layer 3. Similar to the previous exemplary embodiment, the slow axes of the lower and upper λ/4 plates 14b and 24b may form an angle of 45 degrees with the transmission axes of the lower and upper polarizers 12 and 22.

Alternatively, only one of the lower and upper λ/4 plates 14b and 24b may be biaxial.

As the lower compensation film 16p, the lower and upper λ/4 plates 14b and 24b, the lower and upper polarizers 12 and 22, a diffuser 42, an anti-reflection layer 44, an inversion-prism sheet 32, a light guide plate 36, and a lamp 60 are the same as those of the previous exemplary embodiment, detailed descriptions thereof will be omitted.

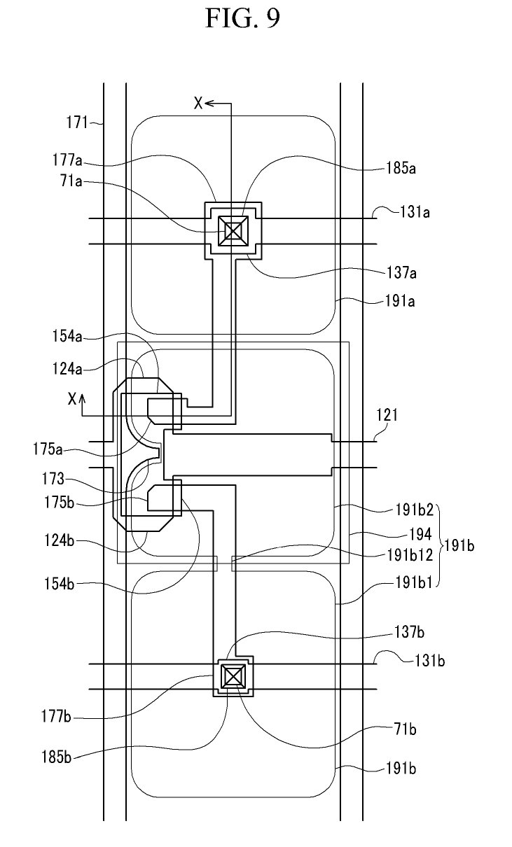

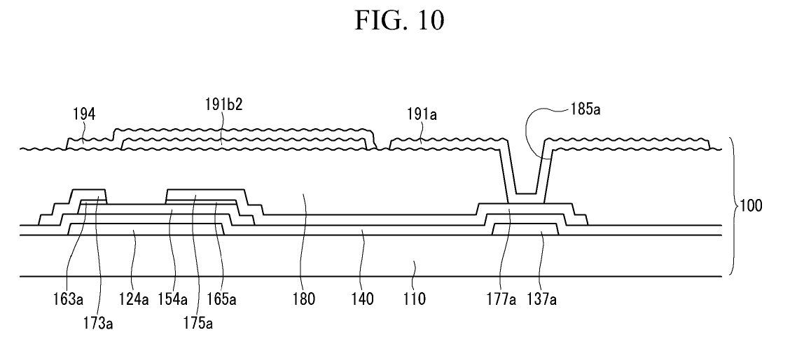

A liquid crystal display according to another exemplary embodiment of the present invention will be described in detail with reference to FIG. 9 and FIG. 10.

FIG. 9 is a layout view of a liquid crystal display according to an exemplary embodiment of the present invention, and FIG. 10 is a cross-sectional view of the liquid crystal display shown in FIG. 9 taken along line X-X thereof.

In the liquid crystal display according to the present exemplary embodiment, first and second storage electrode lines 131a and 131b with first and second storage electrodes 137a and 137b, gate lines 121, data lines 171, first and second drain electrodes 175a and 175b, first and second semiconductor islands 154a and 154b, ohmic contacts 163a and 165a, first thin film transistor (made up of elements 124a, 154a, 173a, and 175a), second thin film transistor (made up of elements 124b, 154b, 173b, and 175b), a gate insulating layer 140, a passivation layer 180, and contact holes 185a and 185b have structures similar to those of the liquid crystal display shown in FIG. 1 and FIG. 2. Furthermore, the liquid crystal display shown in FIG. 9 and FIG. 10 has substantially the same sectional structure as that of the liquid crystal display shown in FIG. 1 and FIG. 2.

However, in the present exemplary embodiment, first and second sub-pixel electrodes 191a and 191b differ in structure from those related to the previous exemplary embodiment.

In the present exemplary embodiment, the first and second sub-pixel electrodes 191a and 191b are indented in accordance with the protrusions and depressions of the passivation layer 180, and the second sub-pixel electrode 191b has an area about two times the area or the first sub-pixel electrode 191b. Also, the second sub-pixel electrode 191b has lower and upper transparent electrodes 191b1 and 191b2, and a reflective electrode 194 disposed on and contacting the lower and upper transparent electrodes 191b1 and 191b2.

The transparent electrodes 191b1 and 191b2 are connected to each other by way of a connector 191b12. The transparent electrodes 191b1 and 191b2 are each roughly square-shaped, and substantially have the same area as the first sub-pixel electrode 191a.

The reflective electrode 194 is disposed on the upper transparent electrode 191b2, which is disposed over the thin film transistor, between the lower and upper transparent electrodes 191b1 and 191b2. Accordingly, it may be possible to prevent the aperture ratio from being reduced due to the thin film transistor.

The first sub-pixel electrode 191a, and the lower and upper transparent electrodes 191b1 and 191b2 may be formed of a transparent conductive material such as ITO and IZO, and the reflective electrode 194 may be formed of a reflective metal such as aluminum, silver, chromium, and alloys thereof. Alternatively, the reflective electrode 194 may have a dual-layer structure with an upper low resistance reflective layer (not shown) based on aluminum, silver, or alloys thereof, and a lower layer (not shown) based on a material exhibiting a good contact characteristic with respect to ITO or IZO, such as molybdenum-based metal, chromium, tantalum, and titanium.

The first and second storage electrode lines 131a and 131b respectively traverse through the centers of the first sub-pixel electrode 191a and the lower transparent electrode 191b1. Alternatively, the first and second storage electrode lines 131a and 131b may be disposed between the first and second sub-pixel electrodes 191a and 191b, or between the lower and upper transparent electrodes 191b1 and 191b2, which may increase the aperture ratio.

In the liquid crystal display according to the present exemplary embodiment, light incident from the thin film transistor array panel 100 passes the first sub-pixel electrode 191a, the transparent electrodes 191b1 and 191b2, and the liquid crystal layer 3, and proceeds toward the common electrode panel 200. Light incident from the common electrode panel 200 to the liquid crystal layer 3 is reflected by the reflective electrode 194, and again passes through from the liquid crystal layer 3 to proceed toward the common electrode panel 200. In this case, the indented portions of the reflective electrode 194 cause the light to be reflected and diffused.

The above-described transflective liquid crystal display may use both internal light and external light.

The operation of the liquid crystal display according to the present exemplary embodiment is substantially the same as that of the liquid crystal display shown in FIG. 1, FIG. 2, FIG. 3, and FIG. 4.

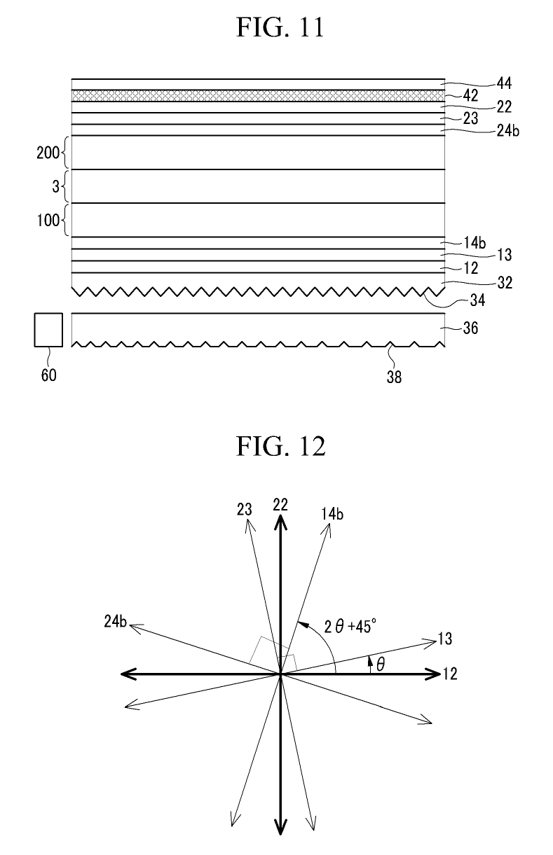

A plurality of optical films or layers for the liquid crystal display shown in FIG. 9 and FIG. 10 will be now described in detail with reference to FIG. 11 and FIG. 12.

FIG. 11 is a schematic cross-sectional view of a liquid crystal display according to an exemplary embodiment of the present invention, and FIG. 12 shows the axial directions of films of the liquid crystal display shown in FIG. 11.

Referring to FIG. 11, a liquid crystal display according to an exemplary embodiment of the present invention has a thin film transistor array panel 100 and a common electrode panel 200, and lower and upper λ/4 plates 14b and 24b, lower and upper λ/2 plates 13 and 23, and lower and upper polarizers 12 and 22 are sequentially attached to the outer surfaces of the panels 100 and 200.

The lower and upper polarizers 12 and 22 each have a transmission axis, and the transmission axes thereof are perpendicular to each other.

The lower and upper λ/2 plates 13 and 23 may be formed of a biaxial film including an NEZ film, and the slow axes thereof may be perpendicular to each other. Furthermore, as shown in FIG. 12, the slow axes of the lower and upper λ/2 plates 13 and 23 may form an angle of θ degrees with the transmission axes of the lower and upper polarizers 12 and 22, respectively. In a transflective liquid crystal display, the lower and upper λ/2 plates 13 and 23 compensate for the phase difference according to viewing angles.

Differently from the present exemplary embodiment, in a transflective liquid crystal display according to another exemplary embodiment, only the upper λ/2 plate 23 may be biaxial, while the lower λ/2 plate 13 is uniaxial.

Similarly to the liquid crystal display shown in FIG. 7 and FIG. 8, the lower and upper λ/4 plates 14b and 24b may be biaxial and have phase retardation value Rth in the thickness direction to compensate for phase differences in the cell-gap direction of the liquid crystal layer 3. The slow axes of the lower and upper λ/4 plates 14b and 24b may be perpendicular to each other. However, differently from the previous exemplary embodiment, the slow axes of the lower and the upper λ/4 plates 14b and 24b may form an angle of 2θ+45° with the transmission axes of the lower and upper polarizers 12 and 22, respectively. The lower and upper λ/4 plates 14b and 24b convert linear-polarized light into circular-polarized light, or vice versa.

Differently from the present exemplary embodiment, one of the lower and upper λ/4 plates 14b and 24b may be biaxial, or a separate biaxial compensation film may be further provided while the lower and upper λ/4 plate 14b and 24b are uniaxial, which is the same as the liquid crystal display shown in FIG. 5 and FIG. 6.

As the lower and upper polarizers 12 and 22, a diffuser 42, an anti-reflection layer 44, an inversion-prism sheet 32, a light guide plate 36, and a lamp 60 have the same structure as those related to the exemplary embodiment shown in FIG. 7 and FIG. 8, a detailed description thereof will be omitted.

As described above, in a liquid crystal display according to an exemplary embodiment of the present invention, the viewing angle may be increased, and the lateral visibility may be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a first substrate and a second substrate;
gate lines arranged on the first substrate;
an insulating layer arranged on the gate lines;
data lines, first drain electrodes, and second drain electrodes arranged on the insulating layer;
first sub-pixel electrodes and second sub-pixel electrodes connected to the first drain electrodes and the second drain electrodes, respectively;
storage electrode lines to receive storage voltages that vary periodically, the storage electrode lines being parallel to the gate lines and traversing at least one of the first sub-pixel electrodes and the second sub-pixel electrodes;
a first polarizer disposed on an outer surface of the first substrate;
a second polarizer disposed on an outer surface of the second substrate;
a first λ/4 plate disposed between the first substrate and the first polarizer;
a second λ/4 plate disposed between the second substrate and the second polarizer; and
a diffuser disposed on an outer surface of the second polarizer.

2. The liquid crystal display of claim 1, wherein the first drain electrodes and second drain electrodes are symmetrically disposed with respect to the gate line.

3. The liquid crystal display of claim 2, wherein the storage electrode lines comprise a first storage electrode overlapping the first sub-pixel electrode, and a second storage electrode overlapping the second sub-pixel electrode.

4. The liquid crystal display of claim 3, wherein the first storage electrode overlaps the first drain electrode, and the second storage electrode overlaps the second drain electrode.

5. The liquid crystal display of claim 4, wherein an overlapping area of the first drain electrode and the first storage electrode is larger than an overlapping area of the second drain electrode and the second storage electrode.

6. The liquid crystal display of claim 1, further comprising a first thin film transistor and a second thin film transistor comprising the first drain electrode and the second drain electrode, respectively, the first sub-pixel electrode and the second sub-pixel electrode receiving a data voltage from the first thin film transistor and the second thin film transistor, respectively.

7. The liquid crystal display of claim 1, further comprising a common electrode arranged on the second substrate, the common electrode comprising a first opening corresponding to a center of the first sub-pixel electrode and a second opening corresponding to a center of the second sub-pixel electrode, respectively.

8. The liquid crystal display of claim 7, wherein a connection region of the first sub-pixel electrode and the first drain electrode corresponds to the first opening, and a connection region of the second sub-pixel electrode and the second drain electrode corresponds to the second opening.

9. The liquid crystal display of claim 1, further comprising a light guide plate arranged on an outer surface of the first polarizer, the light guide plate comprising a plurality of grooves arranged on a surface of the light guide plate.

10. The liquid crystal display of claim 9, wherein each groove has a triangular shape.

11. The liquid crystal display of claim 10, further comprising a light source arranged beside the light guide plate, wherein a distance between neighboring grooves increases with increasing distance from the light source.

12. The liquid crystal display of claim 9, further comprising an inversion-prism sheet arranged between the light guide plate and the first polarizer.

13. The liquid crystal display of claim 12, further comprising an anti-reflection layer disposed on an outer surface of the diffuser.

14. The liquid crystal display of claim 13, wherein the diffuser comprises light diffusion particulates.

15. The liquid crystal display of claim 9, wherein a transmission axis of the first polarizer is perpendicular to a transmission axis of the second polarizer.

16. The liquid crystal display of claim 15, wherein a slow axis of the first λ/4 plate is perpendicular to a slow axis of the second λ/4 plate,
wherein the slow axis of the first λ/4 plate forms an angle of 45 degrees with the transmission axis of the first polarizer, and
wherein the slow axis of the second λ/4 plate forms an angle of 45 degrees with the transmission axis of the second polarizer.

17. The liquid crystal display of claim 16, further comprising a biaxial compensation film disposed between the first polarizer and the first substrate, or between the second polarizer and the second substrate.

18. The liquid crystal display of claim 17, wherein the biaxial compensation film comprises an NEZ film.

19. The liquid crystal display of claim 16, further comprising a compensation film disposed between the first polarizer and the first substrate, or between the second polarizer and the second substrate.

20. The liquid crystal display of claim 19, wherein the compensation film comprises a C-plate or a biaxial film.

21. The liquid crystal display of claim 16, wherein at least one of the first λ/4 plate and the second λ/4 plate is biaxial.

22. The liquid crystal display of claim 9, wherein the second sub-pixel electrode further comprises a transparent electrode and a reflective electrode connected to the transparent electrode.

23. The liquid crystal display of claim 22, further comprising a first λ/2 plate disposed between the first λ/4 plate and the first polarizer, and a second λ/2 plate disposed between the second λ/4 plate and the second polarizer,
wherein a slow axis of the first λ/2 plate and a slow axis of the second λ/2 plate forms an angle of θ degrees with a transmission axes of the first polarizer and a transmission axes of the second polarizer, respectively.

24. The liquid crystal display of claim 23, wherein a slow axis of the first λ/4 plate is perpendicular to a slow axis of the second λ/4 plate,
wherein the slow axis of the first λ/4 plate forms an angle of 2θ+45 degrees with the transmission axis of the first polarizer, and
wherein the slow axis of the second λ/4 plate forms an angle of 2θ+45 degrees with the transmission axis of the second polarizer.

25. The liquid crystal display of claim 24, wherein at least one of the first λ/2 plate and the second λ/2 plate is biaxial.

26. The liquid crystal display of claim 25, wherein at least one of the first λ/2 plate and the second λ/2 plate comprises an NEZ film.

27. The liquid crystal display of claim 24 further comprising a C-plate or a biaxial film disposed between the first polarizer and the second polarizer.

28. The liquid crystal display of claim 24, wherein at least one of the first λ/4 plate and the second λ/4 plate is biaxial.
